(19) United States
(12) Patent Application Publication
(10) Pub. No.: US 2016/0034884 A1
(43) Pub. Date: Feb. 4, 2016

(54) METHOD AND SYSTEM FOR CHARGEBACK OF COUNTERFEIT GOODS

(71) Applicant: MasterCard International Incorporated, Purchase, NY (US)

(72) Inventor: Justin X. HOWE, San Francisco, CA (US)

(73) Assignee: MasterCard International Incorporated, Purchase, NY (US)

(21) Appl. No.: 14/815,125

(22) Filed: Jul. 31, 2015

Related U.S. Application Data
(60) Provisional application No. 62/032,035, filed on Aug. 1, 2014.

(51) Int. Cl. G06Q 20/22; G06Q 20/38

(52) U.S. Cl. CPC G06Q 20/22; G06Q 20/382

(57) ABSTRACT

A method for processing a chargeback of counterfeit goods includes: storing a plurality of transaction data entries, each entry including data related to a processed payment transaction including transaction data and a merchant identifier; receiving a chargeback request, the request including identification data associated with a plurality of payment transactions and an indication of each of the plurality of payment transactions involving the sale of counterfeit goods; identifying a subset of transaction data entries based on the transaction data in each entry in the subset and the identification data in the chargeback request; initiating a chargeback for the processed payment transaction related to each transaction data entry in the subset; and initiating a payment transaction for an amount based on a number of transaction data entries in the subset, wherein the initiated payment transaction involves an entity associated with the chargeback request.

### FIELD

The present disclosure relates to the processing of chargebacks of counterfeit goods, specifically the processing of batch chargebacks against a merchant associated with the sale of counterfeit goods to reduce profit margins for the merchant and the identification of the merchant as a high risk merchant to reduce the likelihood of future transactions.

### BACKGROUND

Products from a merchant or manufacturer that are highly desired by consumers, particularly products that are expensive and with a high profit margin due to notable branding or availability, are often at risk of being copied by other entities. In some cases, a competing merchant may develop their own product similar to the highly desired one for competition. In other cases, a less virtuous merchant may directly copy the product and present it as genuine. The sale of these counterfeit goods can be highly detrimental to consumers, particularly those who are not aware that a good is counterfeit, and to the merchant whose good is being copied, as the sale of counterfeit goods can result in a loss of revenue, loss of value of the product, and may be detrimental to the brand.

As a result, merchants whose goods are being copied often take steps to prevent the manufacture and/or sale of counterfeit goods. The victimized merchant may identify merchants selling the counterfeit goods and may request that the sales be stopped, and may seek remedies from the appropriate authorities. However, such processes can often take a significant amount of time and may require a significant amount of resources. During the time waiting for authorities to prevent the sale of the counterfeit goods, more counterfeit goods may be sold, which may result in additional losses of revenue and damage to the brand of the victimized merchant.

Thus, there is a need for a technical solution to more quickly and efficiently discourage the sale of counterfeit goods by a merchant.

### SUMMARY

The present disclosure provides a description of systems and methods for processing a chargeback of counterfeit goods and identifying a high risk merchant associated with counterfeit goods.

A method for processing a chargeback of counterfeit goods includes: storing, in a transaction database, a plurality of transaction data entries, wherein each transaction data entry includes data related to a processed payment transaction including at least transaction data and a merchant identifier; receiving, by a receiving device, a chargeback request, wherein the chargeback request includes at least identification data associated with a plurality of payment transactions and an indication of each of the plurality of payment transactions involving the sale of counterfeit goods; identifying, in the transaction database, a subset of transaction data entries based on the transaction data included in each transaction data entry in the subset and the identification data included in the received chargeback request; initiating, by a processing device, a chargeback for the processed payment transaction related to each transaction data entry in the identified subset of transaction data entries; and initiating, by the processing device, a payment transaction for an amount based on a number of transaction data entries in the subset of transaction data entries, wherein the initiated payment transaction involves an entity associated with the received chargeback request.

A method for identifying a high risk merchant associated with counterfeit goods includes: storing, in a merchant database, a merchant profile, wherein the merchant profiles includes data related to a merchant including at least a merchant identifier; storing, in a transaction database, a plurality of transaction data entries, wherein each transaction data entry includes data related to a processed payment transaction involving the merchant including at least a transaction amount; storing, in a chargeback database, a plurality of chargeback data entries, wherein each chargeback data entry includes data related to a chargeback associated with the merchant including at least transaction data and a reason code associated with the sale of counterfeit goods; identifying, in the transaction database, a first set of transaction data entries, wherein each transaction data entry in the first set includes transaction data that corresponds to transaction data included in a chargeback data entry of the plurality of chargeback data entries, and a second set of transaction entries, wherein each transaction data entry in the second set includes transaction data that does not correspond to transaction data included in a chargeback data entry of the plurality of chargeback data entries; calculating, by a processing device, a plurality of metrics based on at least the transaction amount included in each transaction data entry included in the identified first set of transaction data entries and the transaction amount included in each transaction data entry included in the identified second set of transaction data entries; and indicating, in the merchant profile, that the related merchant is a high risk merchant based on the calculated plurality of metrics and one or more predefined values.

A system for processing a chargeback of counterfeit goods includes a transaction database, a receiving device, and a processing device. The transaction database is configured to store a plurality of transaction data entries, wherein each transaction data entry includes data related to a processed payment transaction including at least transaction data and a merchant identifier. The receiving device configured to receive a chargeback request, wherein the chargeback request includes at least identification data associated with a plurality of payment transactions and an indication of each of the plurality of payment transactions involving the sale of counterfeit goods. The processing device is configured to: identify, in the transaction database, a subset of transaction data entries based on the transaction data included in each transaction data entry in the subset and the identification data included in the received chargeback request; initiate a chargeback for the processed payment transaction related to each transaction data entry in the identified subset of transaction data entries; and initiate a payment transaction for an amount based on a number of transaction data entries in the subset of transaction data entries, wherein the initiated payment transaction involves an entity associated with the received chargeback request.

A system for identifying a high risk merchant associated with counterfeit goods includes a merchant database, a transaction database, a chargeback database, and a processing device. The merchant database is configured to store a merchant profile, wherein the merchant profile includes data related to a merchant including at least a merchant identifier. The transaction database is configured to store a plurality of transaction data entries, wherein each transaction data entry includes data related to a processed payment transaction involving the merchant including at least a transaction amount. The chargeback database is configured to store a plurality of chargeback data entries, wherein each chargeback data entry includes data related to a chargeback associated with the merchant including at least transaction data and a reason code associated with the sale of counterfeit goods. The processing device is configured to: identify a first set of transaction data entries, wherein each transaction data entry in the first set includes transaction data that corresponds to transaction data included in a chargeback data entry of the plurality of chargeback data entries, and a second set of transaction entries, wherein each transaction data entry in the second set includes transaction data that does not correspond to transaction data included in a chargeback data entry of the plurality of chargeback data entries; calculate a plurality of metrics based on at least the transaction amount included in each transaction data entry included in the identified first set of transaction data entries and the transaction amount included in each transaction data entry included in the identified second set of transaction data entries; and indicate, in the merchant profile, that the related merchant is a high risk merchant based on the calculated plurality of metrics and one or more predefined values.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for processing chargebacks of counterfeit goods and identifying merchants having a high risk associated thereof in accordance with exemplary embodiments.

FIG. 2 is a block diagram illustrating the processing server of FIG. 1 for processing chargebacks of counterfeit goods and identifying high risk merchants in accordance with exemplary embodiments.

FIG. 3 is a flow diagram illustrating a process for processing a batch of chargebacks for the sale of counterfeit goods using the system of FIG. 1 in accordance with exemplary embodiments.

FIG. 4 is a diagram illustrating a process for identifying a merchant as being a high risk associated with the sale of counterfeit goods using the processing server of FIG. 2 in accordance with exemplary embodiments.

FIG. 5 is a flow chart illustrating an exemplary method for processing a chargeback of counterfeit goods in accordance with exemplary embodiments.

FIG. 6 is a flow chart illustrating an exemplary method for identifying a merchant as high risk associated with counterfeit goods in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require and special knowledge in offered products. In some embodiments, an entity involved in a single transaction may be considered a merchant.

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

System for Processing Chargebacks of and Identifying High Risk Merchants Associated with Counterfeit Goods

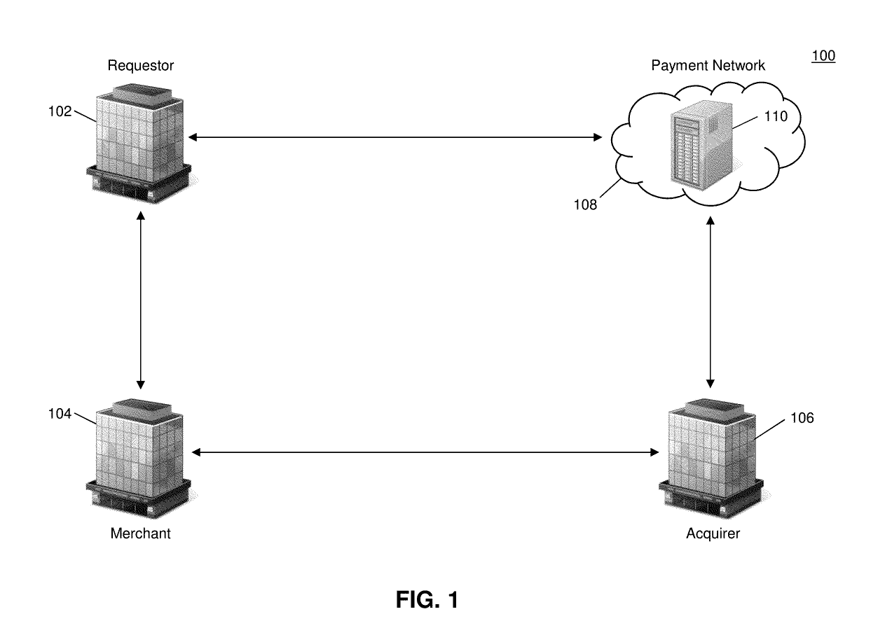

FIG. 1 illustrates a system 100 for the processing of chargebacks for the sale of counterfeit goods and the identification of a merchant associated thereof as being a high risk for acquiring financial institutions.

The system 100 may include a requestor 102. The requestor 102 may be an entity that identifies a merchant 104 that is selling counterfeit goods. Herein, it should be understood that counterfeit goods includes unauthorized copies or knockoffs particularly those that sell using the brand name of another entity without authorization, but it can include grey market goods, goods or services that infringe on the intellectual property (e.g., patent, trademark, copyright or trade secrets) of an entity other than the infringing merchant 104. In some instances, the requestor 102 may be a victimized merchant. The merchant can include an entity that is not selling goods or services but has rights that are being violated by the unauthorized sale by the identified merchant 104, or may be an entity that manufactures and/or sells the original product on which the counterfeit good is based. In other instances, the requestor 102 may be an issuing financial institution associated with a victimized merchant. In some cases, the requestor 102 may be a third party, such as a regulatory agency or entity attempting to prevent the merchant 104 from selling or distributing counterfeit goods.

Each time the merchant 104 makes a sale of counterfeit goods, transaction data for a payment transaction for the sale may be transmitted to an acquirer 106, which may be a financial institution associated with the merchant 104, such as an acquiring bank, that processes payment card and other transactions on behalf of the merchant 104. The acquirer 106 may submit an authorization request for the transaction involving the sale of the counterfeit goods to a payment network 108. The payment network 108 may then process the transaction using methods and systems that will be apparent to persons having skill in the relevant art. As part of the processing, the payment network 108 may store data related to the transaction in a database in a processing server 110 included in the payment network 108, as discussed in more detail below.

The requestor 102 may identify that the merchant 104 is selling counterfeit goods and may, to prevent the sale of the counterfeit goods to other parties, particularly consumers that may otherwise buy a genuine good (e.g., from the requestor 102 or authorized third party retailer), purchase the counterfeit goods from the merchant 104 directly via a plurality of payment transactions. Each payment transaction may be processed by the payment network 108 and transaction details based thereon stored in the processing server 110.

The requestor 102 may then submit a chargeback request for the plurality of purchases of the counterfeit goods to the processing server 110 of the payment network 108. The processing server 110, as discussed in more detail below, may be configured to identify a plurality of previously processed transactions associated with the purchase of counterfeit goods from the merchant 104 based on data included in the chargeback request. The processing server 110 may then initiate a chargeback for the plurality of transactions. In some embodiments, a chargeback may be initiated for each individual transaction. In other embodiments, a single chargeback for an aggregate value of each of the transactions may be initiated by the processing server 110.

The payment network 110 may process the chargebacks using methods and systems that will be apparent to persons having skill in the relevant art. As part of the processing of the chargebacks, the payment network 108 may withdraw an aggregated chargeback amount from a transaction account associated with the acquirer 106. The acquirer 106 may subsequently request reimbursement of that amount from the merchant 104. As a result, the merchant 104 may reimburse the acquirer 106 for the sales of the counterfeit goods, which may result in the merchant 104 surrendering all revenue related to the sale of the counterfeit goods, while at the same time being responsible for payment of fees associated with the transactions and other fees incurred in the sale of goods. This may thereby result in the merchant 104 selling counterfeit goods to operate at a loss or otherwise greatly reduce the profit margin associated with the sale of counterfeit goods. In some cases, this may influence a merchant 104 to cease selling the counterfeit goods more quickly than in instances where traditional means are employed by the requestor 102.

For the processing of the chargebacks, the payment network 108 may charge the requestor 102 a processing fee, such as for operating expenses and other costs associated with the processing of chargebacks. The processing fee may be based on the total number of transactions being charged back, the aggregate chargeback amount, or other suitable criteria that will be apparent to persons having skill in the relevant art. The payment network 108 may also provide the requestor 102 with reimbursement for each of the payment transactions as a result of the chargeback, which may recoup the money spent by the requestor 102 in purchasing the counterfeit goods from the merchant 104.

The requestor 102 may thus prevent the sale of the counterfeit goods to consumers and other third parties for only the processing fee or fees charged by the payment network 110. In addition, as the counterfeit goods purchased by the requestor 102 may prevent the sale of the goods to consumers and other entities, the sale of genuine goods may be thereby increased, which may result in an overall increase in revenue for the requestor 102. Accordingly, the processing of the chargebacks by the processing server 110 may enable the requestor 102 to increase revenue while at the same time lowering profit margins for the merchant 104 and encouraging the merchant 104 to cease in the sale of counterfeit goods.

The processing server 110 may also be configured to identify the merchant 104 as a high risk merchant associated with the sale of counterfeit goods. As discussed in more detail below, the merchant 104 may be identified as a high risk based on one or more metrics associated with the sale of counterfeit goods, such as the frequency of chargebacks due to the sale of counterfeit goods, the overall value of the chargebacks, the portion of revenue for the merchant 104 that is charged back, etc. As part of the identification of the merchant 104 as a high risk, the processing server 110 may notify the acquirer 106 of the merchant's risk status.

The acquirer 106 may thus be notified that the merchant 104 is a high risk merchant, which may indicate that a significant number or value of transactions conducted by the merchant 104, and thereby processed by the acquirer 106, may be charged back, which may result in a decrease in revenue for the acquirer 106 and an increase in expenses. As a result, the acquirer 106 may be encouraged to provide stricter rules or terms for the processing of transactions on behalf of the merchant 104 or may, in some instances, refuse to process transactions for the merchant 104. In such instances, the merchant 104 may be further encouraged to cease the sale of counterfeit goods. Thus, the identification of the merchant 104 as a high risk by the processing server 110 may provide further motivation for a merchant 104 associated with the sale of counterfeit goods to cease in participating in the activity.

### Processing Server

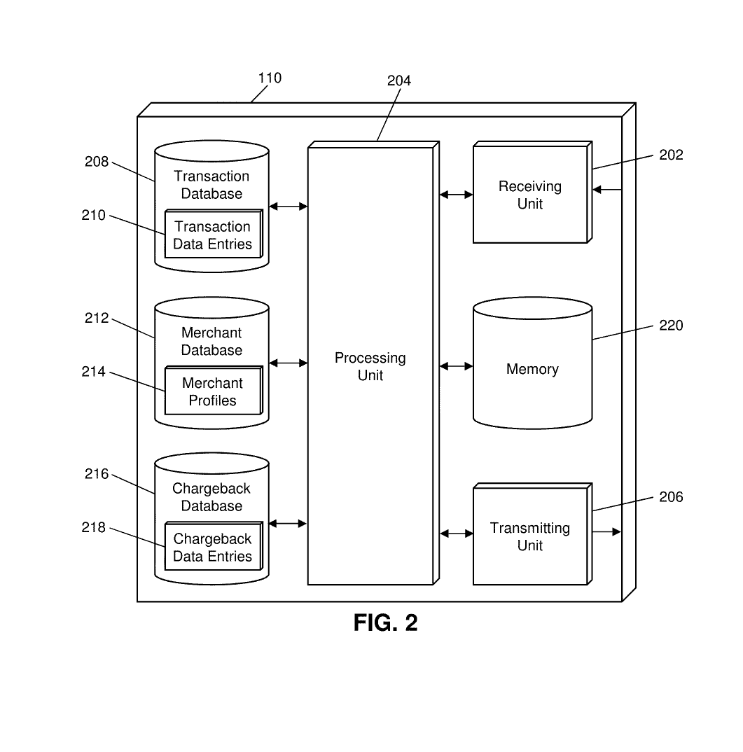

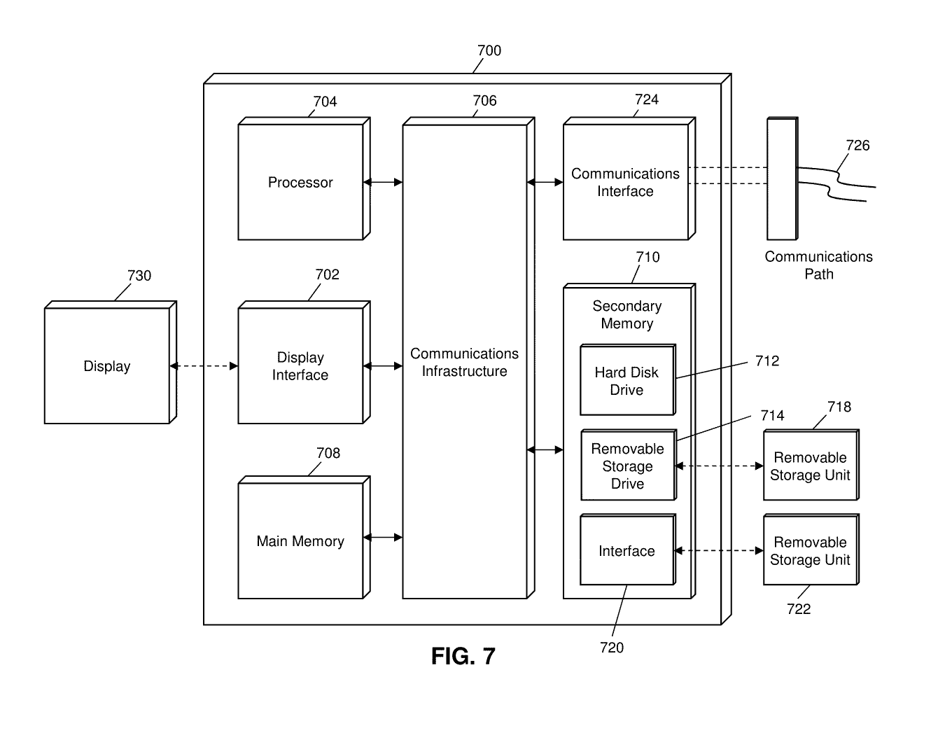

FIG. 2 illustrates an embodiment of the processing server 110 of the system 100. It will be apparent to persons having skill in the relevant art that the embodiment of the processing server 110 illustrated in FIG. 2 is provided as illustration only and may not be exhaustive to all possible configurations of the processing server 110 suitable for performing the functions as discussed herein. For example, the computer system 700 illustrated in FIG. 7 and discussed in more detail below may be a suitable configuration of the processing server 110.

The processing server 110 may include a transaction database 208. The transaction database 208 may be configured to store a plurality of transaction data entries 210. Each transaction data entry 210 may include data related to a processed payment transaction and may include at least transaction data and a merchant identifier. The merchant identifier may be a unique value associated with a merchant 104 involved in the payment transaction such as a merchant identification number, merchant name, registration number, point of sale identifier, reference number, or other suitable value as will be apparent to persons having skill in the relevant art.

The transaction data may include data suitable for the identification of the respective transaction data entry 210, such as a reference number (e.g., for the payment network 108, acquirer 106, merchant 104, etc.), a transaction time and/or date, transaction amount, invoice number, etc. The transaction data may also include additional data associated with the related transaction, such as product data, merchant data, consumer data, etc.

The processing server 110 may also include a merchant database 212. The merchant database 212 may be configured to store a plurality of merchant profiles 214. Each merchant profile 214 may include data related to a merchant 104 including at least a merchant identifier. The merchant identifier may correspond to merchant identifiers included in transaction data entries 210 in the transaction database 208 related to processed payment transactions involving the merchant 104.

The processing server 110 may further include a receiving unit 202. The receiving unit 202 may be configured to receive data over one or more networks via one or more network protocols. The receiving unit 202 may receive transaction data from the payment network 108 for storage in the transaction database 208 as transaction data entries 210. The receiving unit 202 may also receive a chargeback request, such as from the requestor 102. The chargeback request may include identification data for identifying payment transactions to be charged back, and may include an indication that the requested chargebacks are for the sale of counterfeit goods.

The processing server 110 may include a processing unit 204. The processing unit 204 may be configured to perform the functions of the processing server 110 disclosed herein as will be apparent to persons having skill in the relevant art. The processing unit 204 may identify a plurality of transaction data entries 210 in the transaction database 208 that are to be charged back based on the transaction data included therein and the identification data included in the received chargeback request. The identification data may include, for instance, a specific merchant identifier, a plurality of identification numbers (e.g., associated with each payment transaction), a specific transaction amount, a product identifier (e.g., associated with the counterfeit good), and other data suitable for use in identifying transaction data entries 210.

The processing unit 204 may be further configured to initiate a chargeback for the identified transaction data entries 210. In some instances, a single chargeback for an aggregate amount based on the transaction amount for each of the transaction data entries 210 may be initiated. In other instances, the processing unit 204 may initiate a chargeback for each of the transaction data entries 210 identified. In some embodiments, any initiated chargeback may include a reason code associated with the sale of counterfeit goods by the merchant 104.

In some embodiments, the processing unit 204 may be configured to process chargebacks. In other embodiments, a transmitting unit 206 of the processing server 110 may be configured to transmit data associated with chargebacks to the payment network 108 for processing using methods and systems that will be apparent to persons having skill in the relevant art. In embodiments where the processing unit 204 is configured to process chargebacks, the processing unit 204 may be configured to deduct money from an account associated with an acquirer 106 associated with the merchant 104 involved in the identified payment transactions, such as based on data included in a merchant profile 214 related to the merchant 104. The processing unit 204 may also be configured to add the money to an account used to fund each of the transactions, such as based on data included in the respective identified transaction data entries 210. In some instances, the deductions or additions may be performed by other entities and/or computing devices, and instructions or data related thereto transmitted by the transmitting unit 206.

As part of the processing of the chargebacks, the processing unit 204 may also be configured to initiate a payment transaction for payment of a processing fee by the requestor 102 to the payment network 108. In some instances, the processing unit 204 may be configured to process the payment transaction, such as in instances where the processing server 110 may process payment transactions for the payment network 108. In some embodiments, the processing fee may be calculated by the processing unit 204. The processing fee may be based on at least the number of identified transaction data entries 210 that are being charged back.

The processing server 110 may also include a chargeback database 216. The chargeback database 216 may be configured to store a plurality of chargeback data entries 218. Each chargeback data entry 218 may include data related to a chargeback initiated by the processing unit 204 and may include at least transaction data and a reason code. The reason code may be associated with the sale of counterfeit goods. The transaction data may include the transaction data included in the corresponding transaction data entry 210 or a portion thereof. For example, the transaction data included in a chargeback data entry 218 may be data suitable for identifying the corresponding transaction data entry 210. Each chargeback data entry 218 may also include additional data, such as an indication of the status of the related chargeback.

The processing unit 204 may be further configured to calculate a plurality of metrics for a merchant profile 214 based on transactions and chargebacks involving the related merchant 104. The processing unit 204 may identify a first subset of transaction data entries 210 that include merchant identifiers associated with a merchant identifier of a specific merchant profile 214 and that correspond to a chargeback data entry 218 stored in the chargeback database 216. The processing unit 204 may identify a second subset of transaction data entries 210 that include the merchant identifier of a specific merchant profile 214 but that do not correspond to a chargeback data entry 218. The processing unit 204 may then calculate the plurality of metrics based on at least the transaction amounts included in each transaction data entry 210 included in each of the two identified subsets.

The processing unit 204 may be further configured to compare the calculated plurality of metrics with one or more predefined values to determine if the related merchant 104 is a high risk merchant. The predefined values may be based on each of the metrics calculated, such as a value of charged back transactions, frequency of charged back transactions, number of charged back transactions, or ratio thereof compared to transactions that were not charged back. The predefined values may be stored in a memory 220 of the processing server 110. The memory 220 may be configured to store data suitable for performing the functions disclosed herein, such as the predefined values, algorithms for the calculation of the metrics, etc.

In some embodiments, the processing unit 204 may calculate metrics for periods of time. For instance, the processing unit 204 may calculate a metric (e.g., percentage of transactions charged back for the sale of counterfeit goods) for each month for three consecutive months. In such an instance, the identification of the related merchant 104 as being high risk may be further based on a calculated metric over time as compared to a predefined value. For instance, if the merchant 104 has a specific percentage or higher of transactions charged back over a specific period of time.

If a merchant 104 is identified as a high risk merchant, the processing unit 204 may be configured to store an indication of the merchant 104 as being high risk in the related merchant profile 214. The transmitting unit 206 may also be configured to transmit a notification to one or more acquirers 106, such as an acquirer 106 associated with the merchant 104, that the merchant 104 has been identified as a high risk merchant.

It will be apparent to persons having skill in the relevant art that the components of the processing server 110 illustrated in FIG. 2 and discussed herein may be configured to perform additional functions of the processing server 110. For example, in instances where the processing server 110 is configured to process payment transactions and/or chargebacks for the payment network 108, the components of the processing server 110 may be further configured to perform the functions suitable for the processing thereof as will be apparent to persons having skill in the relevant art.

### Process for Processing Chargebacks for the Sale of Counterfeit Goods

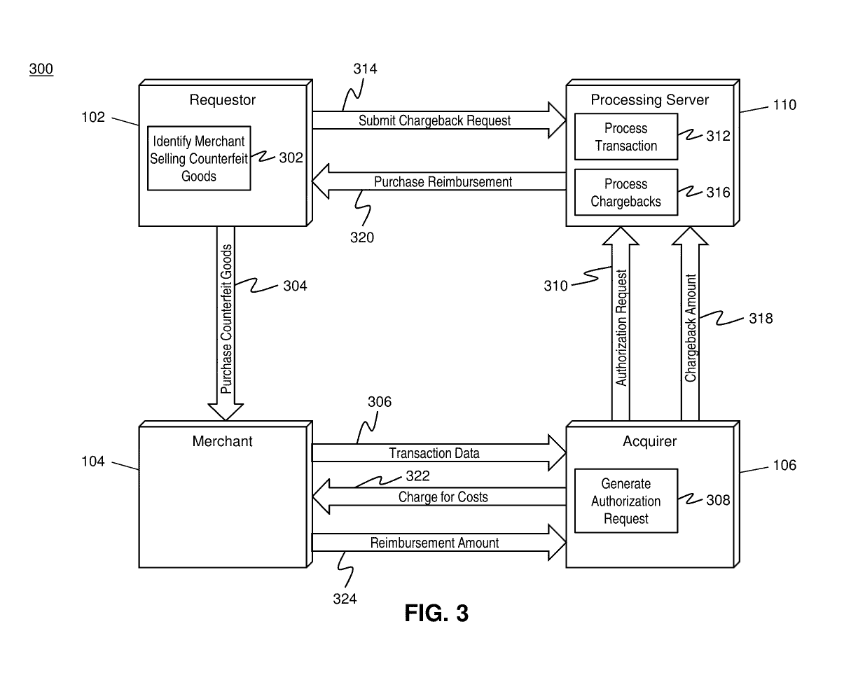

FIG. 3 illustrates a process 300 for the processing of chargebacks by the processing server 110 on behalf of the requestor 102 for the sale of counterfeit goods by the merchant 104.

In step 302, the requestor 102 may identify the merchant 104 as being involved in the sale of counterfeit goods. Methods for identifying a merchant 104 involved in the sale of counterfeit goods, or the identification of counterfeit goods being sold, will be apparent to persons having skill in the relevant art. In step 304, the requestor 102 may purchase counterfeit goods from the merchant 104 across a plurality of payment transactions. For each payment transaction, the merchant 104 may transmit, in step 306, transaction data for the payment transaction to the acquirer 106. In step 308, the acquirer 106 may generate an authorization request for each of the payment transactions.

In step 310, the acquirer 106 may submit each authorization request to the processing server 110 of the payment network 108 for processing. In step 312, the receiving unit 202 of the processing server 110 may receive the authorization requests and the processing unit 204 of the processing server 110 may process the payment transactions using methods and systems that will be apparent to persons having skill in the relevant art. As part of the processing of the payment transactions, the processing unit 204 may store transaction data entries 210 for each transaction in the transaction database 208. It will also be apparent to persons having skill in the relevant art that the processing of the payment transactions may include the transmitting (e.g., by the transmitting unit 206) of an authorization response to the acquirer 106 for forwarding to the merchant 104, which may prompt the merchant 104 to provide the counterfeit goods to the requestor 102.

In step 314, the requestor 102 may submit a chargeback request to the processing server 110. The chargeback request may be received by the receiving unit 202 and may include at least identification data associated with the processed payment transactions and may also include an indication that each of the payment transactions involved the sale of counterfeit goods. In some embodiments, the chargeback request may include a processing fee paid by the requestor 102. The processing fee may be based on the number of payment transactions for which chargeback is requested. In step 316, the processing unit 204 may initiate and process chargebacks for each of the payment transactions as identified via the identification data included in the chargeback request. Each of the chargebacks may include a reason code associated with the sale of counterfeit goods. In some embodiments, the processing unit 204 may generate and store a chargeback data entry 218 in the chargeback database 216 for each chargeback.

As part of the processing of the chargebacks, in step 318, the acquirer 106 may pay an aggregated chargeback amount to the processing server 110 (e.g., or to the payment network 108 to which the processing server 110 belongs). In some instances, the processing server 110 may directly deduct the aggregate chargeback amount from an account associated with the acquirer 106. In step 320, the processing server 110 (e.g., or the payment network 108) may provide reimbursement to the requestor 102 for the purchased made in each of the payment transactions. In step 322, the acquirer 106 may charge the merchant 104 for costs incurred by the acquirer 106 as a result of the chargebacks, such as the aggregate chargeback amount paid by the acquirer 106 to the payment network 108. In step 324, the merchant 104 may provide the charged costs to the acquirer 106 for reimbursement of the costs incurred. The result is that the merchant 104 may be responsible for the costs incurred for the sales of the counterfeit goods, yet not retain any of the revenue due to the chargebacks.

### Process for Identification of a High Risk Merchant

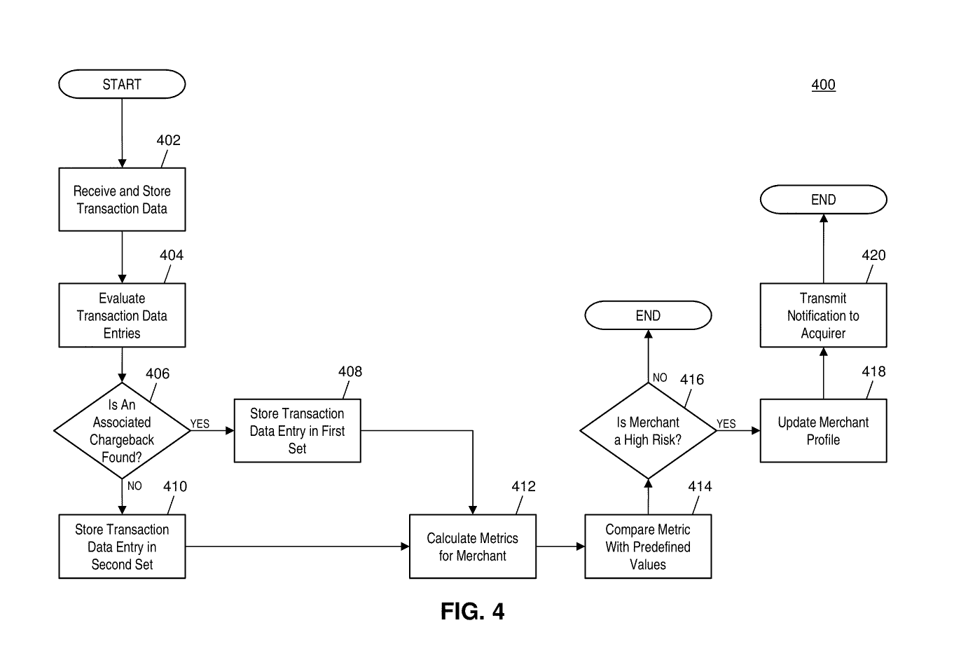

FIG. 4 illustrates a process 400 of the processing server 110 for identifying a merchant 104 as being a high risk associated with the sale of counterfeit goods.

In step 402, the processing server 110 may store transaction data for a plurality of payment transactions and chargebacks in the transaction database 208 and the chargeback database 216, respectively. For instance, the data may be received and/or generated by the processing server 110 as part of the process 300 illustrated in FIG. 3 and discussed above. In step 404, the processing unit 204 may identify transaction data entries 210 stored in the transaction database 208 that are associated with a specific merchant 104, based on the merchant identifier included in a related merchant profile 214, and may evaluate each transaction data entry 210 to identify if a corresponding chargeback data entry 218 is stored in the chargeback database 216 based on the transaction data included therein.

In step 406, the processing unit 204 may determine if an associated chargeback data entry 218 was found for each identified transaction data entry 210. For transaction data entries 210 where an associated chargeback data entry 218 was found, then, in step 408, the processing unit 204 may store those transaction data entries 210 in a first set of transaction data entries. For transaction data entries 210 where no associated chargeback data entry 218 is found, the processing unit 204 may store the transaction data entries 210 in a second set of transaction data entries, in step 410. In some embodiments, the processing unit 204 may separate the transaction data entries 210 based on chargebacks that include a reason code associated with the sale of counterfeit goods.

Once the identified transaction data entries 210 have been separated, then, in step 412, the processing unit 204 may calculate a plurality of metrics for the merchant 104 based on at least the transaction amounts included in each of the two sets of transaction data entries. The plurality of metrics may include a value of charged back transactions, frequency of charged back transactions, number of charged back transactions, or ratio thereof compared to transactions that were not charged back. In some instances, the plurality of metrics may include multiple calculations of a single metric over time. For example, in one embodiment, the processing unit 204 may calculate an overall amount charged back and a percentage value of the amount charged back compared to all transactions for the merchant 104 for each month for two consecutive months. Of course, it is possible that a government agency, court, regulatory group, etc. could supply identities of high risk merchants.

In step 414, the processing unit 204 may compare the calculated metrics with predefined values, such as stored in the memory 220 of the processing server 110. In step 416, the processing unit 204 may determine if the merchant 104 poses a high risk based on the comparison performed in step 414. For example, the processing unit 204 may determine if the calculated overall amount charged back for each of the two months exceeds a predefined value of $5,000 and if the percentage value of the amount charged back for each of the two months exceeds 1%. If the merchant 104 is not identified as a high risk merchant, then the process 400 may be completed.

If the merchant 104 is identified as a high risk merchant, then, in step 418, the processing unit 204 may update their related merchant profile 214 to indicate that the related merchant 104 is a high risk merchant. In step 420, the transmitting unit 206 of the processing server 110 may transmit a notification to the acquirer 106 associated with the merchant 104 that indicates that the merchant 104 has been identified as a high risk merchant associated with the sale of counterfeit goods.

### Exemplary Method for Processing a Chargeback of Counterfeit Goods

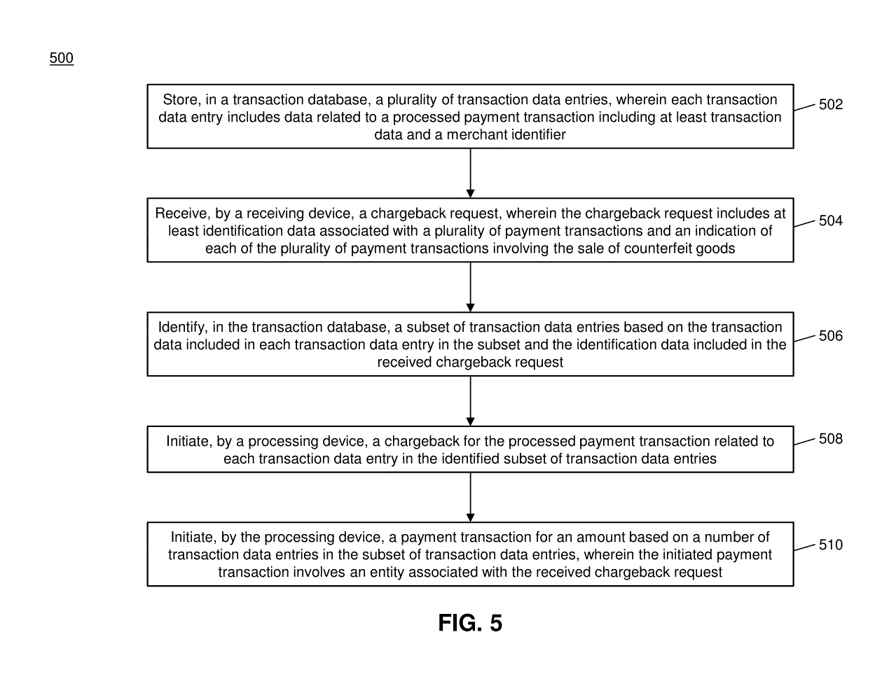

FIG. 5 illustrates a method 500 for the processing of a chargeback for a plurality of payment transactions involving the sale of counterfeit goods.

In step 502, a plurality of transaction data entries (e.g., transaction data entries 210) may be stored in a transaction database (e.g., the transaction database 208), wherein each transaction data entry 210 includes data related to a processed payment transaction including at least transaction data and a merchant identifier. In step 504, a chargeback request may be received by a receiving device (e.g., the receiving unit 202), wherein the chargeback request includes at least identification data associated with a plurality of payment transactions and an indication of each of the plurality of payment transactions involving the sale of counterfeit goods. In some embodiments, the identification data may include at least one of: a plurality of identification numbers, a specific merchant identifier, a specific transaction amount, and a product identifier.

In step 506, a subset of transaction data entries 210 may be identified in the transaction database 208 based on the transaction data included in each transaction data entry 210 in the subset and the identification data included in the received chargeback request. In one embodiment, the identification data may include a specific merchant identifier, and each transaction data entry 210 in the subset may include the specific merchant identifier.

In step 508, a chargeback may be initiated, by a processing device (e.g., the processing unit 204), for the processed payment transaction related to each transaction data entry 210 in the identified subset of transaction data entries 210. In one embodiment, each transaction data entry 210 may further include a transaction amount, and initiating the chargeback may include initiating a single chargeback for an amount based on the transaction amount included in each transaction data entry 210 in the identified subset of transaction data entries. In some embodiments, the initiated chargeback may be associated with a reason code corresponding to the sale of counterfeit goods. The charge-back is not initiated by the return of any goods, but by identification of the goods as counterfeit, perhaps through testing or other forms of inspection, or the merchant as being identified as being of sufficiently high risk as described herein or another suitable means, perhaps by the requestor 102 or a third party. The goods would not normally be returned, of course.

In step 510, a payment transaction may be initiated, by the processing device 204, for an amount based on a number of transaction data entries 210 in the subset of transaction data entries 210, wherein the initiated payment transaction involves an entity (e.g., the requestor 102) associated with the received chargeback request. In some embodiments, the initiated payment transaction may further involve a payment network (e.g., the payment network 108) associated with the initiated chargeback. In one embodiment, the method 500 may further include calculating, by the processing device 204, the amount based on the number of transaction data entries 210 in the subset of transaction data entries 210 and a predetermined processing fee amount.

Exemplary Method for Identifying a High Risk Merchant Associated with Counterfeit Goods

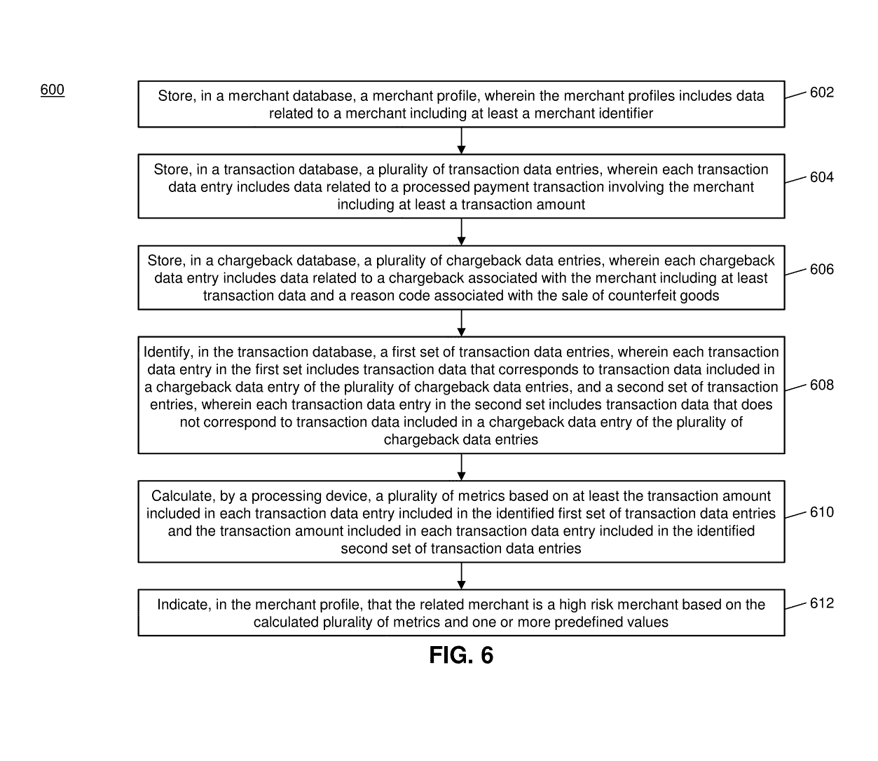

FIG. 6 illustrates a method 600 for the identification of a merchant as a high risk merchant based on chargebacks related to the sale of counterfeit goods.

In step 602, a merchant profile (e.g., the merchant profile 214) may be stored in a merchant database (e.g., the merchant database 212), wherein the merchant profile 214 includes data related to a merchant (e.g., the merchant 104) including at least a merchant identifier. In step 604, a plurality of transaction data entries (e.g., transaction data entries 210) may be stored in a transaction database (e.g., the transaction database 208), wherein each transaction data entry 210 includes data related to a processed payment transaction involving the merchant 104 including at least a transaction amount.

In step 606, a plurality of chargeback data entries (e.g., chargeback data entries 218) may be stored in a chargeback database (e.g., the chargeback database 216), wherein each chargeback data entry 218 includes data related to a chargeback associated with the merchant 104 including at least transaction data and a reason code associated with the sale of counterfeit goods. In step 608, a first set and second set of transaction data entries 210 may be identified, wherein each transaction data entry 210 in the first set includes transaction data that corresponds to transaction data included in a chargeback data entry 218 of the plurality of chargeback data entries 218, and wherein each transaction data entry 210 in the second set includes transaction data that does not correspond to transaction data included in a chargeback data entry 218 of the plurality of chargeback data entries 218.

In step 610, a plurality of metrics may be calculated by a processing device (e.g., the processing unit 204) based on at least the transaction amount included in each transaction data entry 210 included in the identified first set of transaction data entries 210 and the transaction amount included in each transaction data entry 210 included in the identified second set of transaction data entries 210. In one embodiment, the plurality of metrics may include at least one of: chargeback value, chargeback frequency, number of chargebacks, revenue ratio, chargeback ratio, revenue amount, transaction frequency, and number of transactions.

In some embodiments, each transaction data entry 210 may further include a transaction time and/or date, each metric may be associated with a period of time, and each metric may be further based on the transaction amount included in each transaction data entry 210 of the first set that includes a transaction time and/or date included in the associated period of time and the transaction amount included in each transaction data entry 210 in the second set that includes a transaction time and/or date included in the associated period of time. In step 612, the processing device 204 may indicate, in the merchant profile 214, that the related merchant 104 is a high risk merchant based on the calculated plurality of metrics and one or more predefined values. Thereafter, the merchant 104 may be required to pay higher processing fees to reflect a higher risk, mandate additional withholding amounts, and may be blocked from using the payment network. A victimized merchant may repeatedly purchase counterfeit goods in accordance with the first embodiment, thereby encouraging or forcing the merchant 104 be identified as a high risk merchant under the second embodiment disclosed herein.

### Computer System Architecture

FIG. 7 illustrates a computer system 700 in which embodiments of the present disclosure, or portions thereof, may be implemented as computer-readable code. For example, the processing server 110 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3-6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

Techniques consistent with the present disclosure provide, among other features, systems and methods for processing chargebacks for counterfeit goods and identifying high risk merchants associated with the sale of counterfeit goods. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for processing a chargeback of counterfeit goods, comprising:
storing, in a transaction database, a plurality of transaction data entries, wherein each transaction data entry includes data related to a processed payment transaction including at least transaction data and a merchant identifier;
receiving, by a receiving device, a chargeback request, wherein the chargeback request includes at least identification data associated with a plurality of payment transactions and an indication of each of the plurality of payment transactions involving the sale of counterfeit goods;
identifying, in the transaction database, a subset of transaction data entries based on the transaction data included in each transaction data entry in the subset and the identification data included in the received chargeback request;
initiating, by a processing device, a chargeback for the processed payment transaction related to each transaction data entry in the identified subset of transaction data entries; and
initiating, by the processing device, a payment transaction for an amount based on a number of transaction data entries in the subset of transaction data entries, wherein the initiated payment transaction involves an entity associated with the received chargeback request.

2. The method of claim 1, wherein
the identification data includes at least a specific merchant identifier, and
each transaction data entry in the subset includes the specific merchant identifier.

3. The method of claim 1, wherein the identification data includes at least one of: a plurality of identification numbers, a specific merchant identifier, a specific transaction amount, and a product identifier.

4. The method of claim 1, wherein the initiated payment transaction further involves a payment network associated with the initiated chargeback.

5. The method of claim 1, wherein
each transaction data entry further includes a transaction amount,
initiating a chargeback for the processed payment transaction related to the each transaction data entry in the identified subset of transaction data entries includes initiating a single chargeback for an amount based on the transaction amount included in each transaction data entry in the identified subset of transaction data entries.

6. The method of claim 1, further comprising:
calculating, by the processing device, the amount based on the number of transaction data entries in the subset of transaction data entries and a predetermined processing fee amount.

7. The method of claim 1, wherein the initiated chargeback is associated with a reason code corresponding to the sale of counterfeit goods.

8. A method for identifying a high risk merchant associated with counterfeit goods, comprising:
storing, in a merchant database, a merchant profile, wherein the merchant profiles includes data related to a merchant including at least a merchant identifier;
storing, in a transaction database, a plurality of transaction data entries, wherein each transaction data entry includes data related to a processed payment transaction involving the merchant including at least a transaction amount;
storing, in a chargeback database, a plurality of chargeback data entries, wherein each chargeback data entry includes data related to a chargeback associated with the merchant including at least transaction data and a reason code associated with the sale of counterfeit goods;
identifying, in the transaction database, a first set of transaction data entries, wherein each transaction data entry in the first set includes transaction data that corresponds to transaction data included in a chargeback data entry of the plurality of chargeback data entries, and a second set of transaction entries, wherein each transaction data entry in the second set includes transaction data that does not correspond to transaction data included in a chargeback data entry of the plurality of chargeback data entries;
calculating, by a processing device, a plurality of metrics based on at least the transaction amount included in each transaction data entry included in the identified first set of transaction data entries and the transaction amount included in each transaction data entry included in the identified second set of transaction data entries; and
indicating, in the merchant profile, that the related merchant is a high risk merchant based on the calculated plurality of metrics and one or more predefined values.

9. The method of claim 8, wherein the plurality of metrics include at least one of: chargeback value, chargeback frequency, number of chargebacks, revenue ratio, chargeback ratio, revenue amount, transaction frequency, and number of transactions.

10. The method of claim 8, wherein
each transaction data entry further includes a transaction time and/or date,
each metric in the plurality of metrics is associated with a period of time, and
each metric in the plurality of metrics is further based on the transaction amount included in each transaction data entry included in the identified first set of transaction data entries that includes a transaction time and/or date included in the associated period of time and the transaction amount included in each transaction data entry included in the identified second set of transaction data entries that includes a transaction time and/or date included in the associated period of time.

11. A system for processing a chargeback of counterfeit goods, comprising:
a transaction database configured to store a plurality of transaction data entries, wherein each transaction data entry includes data related to a processed payment transaction including at least transaction data and a merchant identifier;
a receiving device configured to receive a chargeback request, wherein the chargeback request includes at least identification data associated with a plurality of payment transactions and an indication of each of the plurality of payment transactions involving the sale of counterfeit goods; and
a processing device configured to
identify, in the transaction database, a subset of transaction data entries based on the transaction data included in each transaction data entry in the subset and the identification data included in the received chargeback request,
initiate a chargeback for the processed payment transaction related to each transaction data entry in the identified subset of transaction data entries, and
initiate a payment transaction for an amount based on a number of transaction data entries in the subset of transaction data entries, wherein the initiated payment transaction involves an entity associated with the received chargeback request.

12. The system of claim 11, wherein
the identification data includes at least a specific merchant identifier, and
each transaction data entry in the subset includes the specific merchant identifier.

13. The system of claim 11, wherein the identification data includes at least one of: a plurality of identification numbers, a specific merchant identifier, a specific transaction amount, and a product identifier.

14. The system of claim 11, wherein the initiated payment transaction further involves a payment network associated with the initiated chargeback.

15. The system of claim 11, wherein
each transaction data entry further includes a transaction amount,
initiating a chargeback for the processed payment transaction related to the each transaction data entry in the identified subset of transaction data entries includes initiating a single chargeback for an amount based on the transaction amount included in each transaction data entry in the identified subset of transaction data entries.

16. The system of claim 11, wherein the processing device is further configured to calculate the amount based on the number of transaction data entries in the subset of transaction data entries and a predetermined processing fee amount.

17. The system of claim 11, wherein the initiated chargeback is associated with a reason code corresponding to the sale of counterfeit goods.

18. A system for identifying a high risk merchant associated with counterfeit goods, comprising:
a merchant database configured to store a merchant profile, wherein the merchant profiles includes data related to a merchant including at least a merchant identifier;
a transaction database configured to store a plurality of transaction data entries, wherein each transaction data entry includes data related to a processed payment transaction involving the merchant including at least a transaction amount;
a chargeback database configured to store a plurality of chargeback data entries, wherein each chargeback data entry includes data related to a chargeback associated with the merchant including at least transaction data and a reason code associated with the sale of counterfeit goods; and
a processing device configured to
identify a first set of transaction data entries, wherein each transaction data entry in the first set includes transaction data that corresponds to transaction data included in a chargeback data entry of the plurality of chargeback data entries, and a second set of transaction entries, wherein each transaction data entry in the second set includes transaction data that does not correspond to transaction data included in a chargeback data entry of the plurality of chargeback data entries,
calculate a plurality of metrics based on at least the transaction amount included in each transaction data entry included in the identified first set of transaction data entries and the transaction amount included in each transaction data entry included in the identified second set of transaction data entries, and
indicate, in the merchant profile, that the related merchant is a high risk merchant based on the calculated plurality of metrics and one or more predefined values.

19. The system of claim 18, wherein the plurality of metrics include at least one of: chargeback value, chargeback frequency, number of chargebacks, revenue ratio, chargeback ratio, revenue amount, transaction frequency, and number of transactions.

20. The system of claim 18, wherein
each transaction data entry further includes a transaction time and/or date,
each metric in the plurality of metrics is associated with a period of time, and
each metric in the plurality of metrics is further based on the transaction amount included in each transaction data entry included in the identified first set of transaction data entries that includes a transaction time and/or date included in the associated period of time and the transaction amount included in each transaction data entry included in the identified second set of transaction data entries that includes a transaction time and/or date included in the associated period of time.
